(19) United States
(12) Patent Application Publication
(10) Pub. No.: US 2003/0108078 A1
(43) Pub. Date: Jun. 12, 2003

(54) Medical laser system

(76) Inventors: Delwin K. McCarthy, Cerritos, CA (US); Robert H. Gregg II, Cerritos, CA (US); Rick Thompson, Fairfield, CA (US); Michael Yessik, Richmond, CA (US)

Correspondence Address: Patent & Law Venture Group, Suite K-105, 3151 Airway Ave., Costa Mesa, CA, 92626, US

(21) Appl. No.: 10/020,846

(22) Filed: Dec. 11, 2001

(51) Int. Cl. H01S 3/10; H01S 3/00; H01S 3/09

(52) U.S. Cl. 372/69; 372/25

(57) ABSTRACT

A laser pulse driving method comprises the steps of selecting a desired laser pulse energy level and a laser pulse width, and then determining a target flashlamp current level corresponding to the laser pulse energy level and the laser pulse width. Further, the method teaches generating a reference voltage corresponding to the target flashlamp current level at a first input of a comparator, closing a power switch to deliver an actual flashlamp current level to the flashlamp from a pulse capacitor, and then presenting a shunt voltage proportional to the actual flashlamp current level at a second input of the comparator. Further steps include, turning-on a comparator output when the shunt voltage is less than the reference voltage, receiving the comparator output at a first AND gate input, receiving a control signal at a second AND gate input for a time equal to the laser pulse width and then applying the AND gate output at a power switch driver when both the first and the second AND gate inputs are present. A power switch delivers the actual flashlamp current level from the pulse capacitor when the AND gate output is present whereby the laser pulse energy level is applied to the flashlamp in a laser pulse having the desired laser pulse energy level and laser pulse width.

### BACKGROUND OF THE INVENTION

1. Field of the Invention

This invention relates generally to optical pumping of laser media and more particularly to a system for control of the optical pumping of a laser by software control of pulse energy through direct control of pulse width and height. The control technique is ideal for applications in laser surgery in dental applications.

2. Description of Related Art

The following art defines the present state of this field:

Logan, U.S. Pat. No. 4,398,129 describes a flashlamp drive circuit using an unsaturated transistor as a current mode switch to periodically subject a partially ionized gaseous laser excitation flashlamp to a stable, rectangular pulse of current from an incomplete discharge of an energy storage capacitor. A monostable multivibrator sets the pulse interval, initiating the pulse in response to a flash command by providing a reference voltage to a non-inverting terminal of a base drive amplifier; a tap on an emitter resistor provides a feedback signal sensitive to the current amplitude to an inverting terminal of amplifier, thereby controlling the pulse amplitude. The circuit drives flashlamp to provide a square-wave current flashlamp discharge.

Carvalho, U.S. Pat. No. 5,255,277 describes a flashlamp pumped laser which is controlled to emit a series of narrow pulse width laser pulses in quick succession. A control circuit associated with the flashlamp receives firing signals of limited pulse duration and serves to ignite and extinguish the flashlamp in accordance with the leading and trailing edges of a single firing signal pulse. The laser generates a coherent light pulse corresponding to the pumping flashlamp pulse. The flashlamp control circuit includes a main capacitor which stores electric charge sufficient to provide current to the flashlamp for several pulses in succession. The circuit also includes a trigger capacitor which supplies current through a transformer coupled to the flashlamp to initiate current conduction therein. Both circuit paths, the main path through the flashlamp and the auxiliary path from the trigger capacitor, are commonly connected to an Insulated Gate Bipolar Transistor (IGBT) which serves as a switch to turn the flashlamp on and off in response to a firing signal pulse.

Negus et al., U.S. Pat. No. 5,455,837 describes a circuit for controlling the output of a flashlamp used to excite a gain medium. The circuit functions to supply energy to the flashlamp for fixed time intervals to generate repetitive pulses having a uniform duration. The circuit includes a photodetector for generating an output signal which is proportional to the light generated by the flashlamp. During a first phase of the fixed interval, the circuit delivers a first voltage level to the flashlamp. At the end of the first phase, a comparison is made between the output of the flashlamp as measured by the photodetector and a target output level. The circuit also initiates a second, boost phase where the voltage supplied to the flashlamp is increased. The length of the boost phase is selected so that at the end of the fixed interval, the total light output generated by the flashlamp is substantially equal to the desired output level.

Langhans et al., U.S. Pat. No. 5,497,051 describes a current supply means for a laser flash lamp containing a fast switch and control means which modulate the amplitude of each individual pulse with a presettable modulating frequency and depth of modulation. This permits higher peak envelope powers to be obtained at an unchanged mean power of the individual pulses so that the necessary threshold values can be better exceeded during materials processing. The amplitude modulation of the individual pulses also prevents undesirable shielding plasma from forming above the processing place.

Langhans et al., U.S. Pat. No. 5,585,698 describes a current supply means for a laser flash lamp containing a fast switch and control means which modulate the amplitude of each individual pulse with a presettable modulating frequency and depth of modulation. This permits higher peak envelope powers to be obtained at an unchanged mean power of the individual pulses so that the necessary threshold values can be better exceeded during materials processing. The amplitude modulation of the individual pulses also prevents undesirable shielding plasma from forming above the processing place.

Renz, U.S. Pat. No. 5,895,984 describes a circuit arrangement for feeding a pulse output stage which has at least one capacitor and, connected to the latter, a load, for example a diode laser. The capacitor is connected to a voltage source via a coil. The voltage of the voltage source is applied to the coil by means of a pulsed switching device. The energy stored in the coil is used to charge the capacitor. The latter is discharged by the same or a further switching device, generating a useful pulse through the load.

The prior art teaches the use of flashlamp driver circuits but does not teach a circuit capable of dynamically controlling the flashlamp drive current pulse with high uniformity in pulse magnitude across the entire pulse width. The prior art does not teach pulse height and width control from software parameters. The present invention fulfills these needs and provides further related advantages as described in the following summary.

### SUMMARY OF THE INVENTION

The present invention teaches certain benefits in construction and use which give rise to the objectives described below.

A laser pulse driving method comprises the steps of selecting a desired laser pulse energy level and a laser pulse width, and then determining a target flashlamp current level corresponding to the laser pulse energy level and the laser pulse width. Further, the method teaches generating a reference voltage corresponding to the target flashlamp current level at a first input of a comparator, closing a power switch to deliver an actual flashlamp current level to the flashlamp from a pulse capacitor, and then presenting a shunt voltage proportional to the actual flashlamp current level at a second input of the comparator. Further steps include, turning-on a comparator output when the shunt voltage is less than the reference voltage, receiving the comparator output at a first AND gate input, receiving a control signal at a second AND gate input for a time equal to the laser pulse width and then applying the AND gate output at a power switch driver when both the first and the second AND gate inputs are present. A power switch delivers the actual flashlamp current level from the pulse capacitor when the AND gate output is present whereby the laser pulse energy level is applied to the flashlamp in a laser pulse having the desired laser pulse energy level and laser pulse width. It has been discovered that the present invention, through improved control of the magnitude of the laser energy pulse, and also through sharp leading and trailing edges, is able to provide a very significant improvement in surgical cutting by directing more energy to the dissociation of tissue and less to heat. This results in improvements in quality, speed and accuracy in the surgeon's hands.

A primary objective of the present invention is to provide an apparatus and method of use of such apparatus, that provides advantages not taught by the prior art.

Another objective is to provide such an invention capable of precise control over pulse height for the full duration of the pulse.

A further objective is to provide such an invention capable of software control over the pulse duration and pulse height.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a block diagram of the preferred embodiment of the invention;

FIG. 2 is a coordinate timing diagram thereof;

FIG. 3 is a time vs current magnitude graph comparing pulse frequency and duration for high and low current laser operation; and

FIG. 4 is a time vs laser output amplitude graph comparing typical control for the present invention and the prior art.

### DETAILED DESCRIPTION OF THE INVENTION

The above described drawing figures illustrate the invention in at least one of its preferred embodiments, which is further defined in detail in the following description.

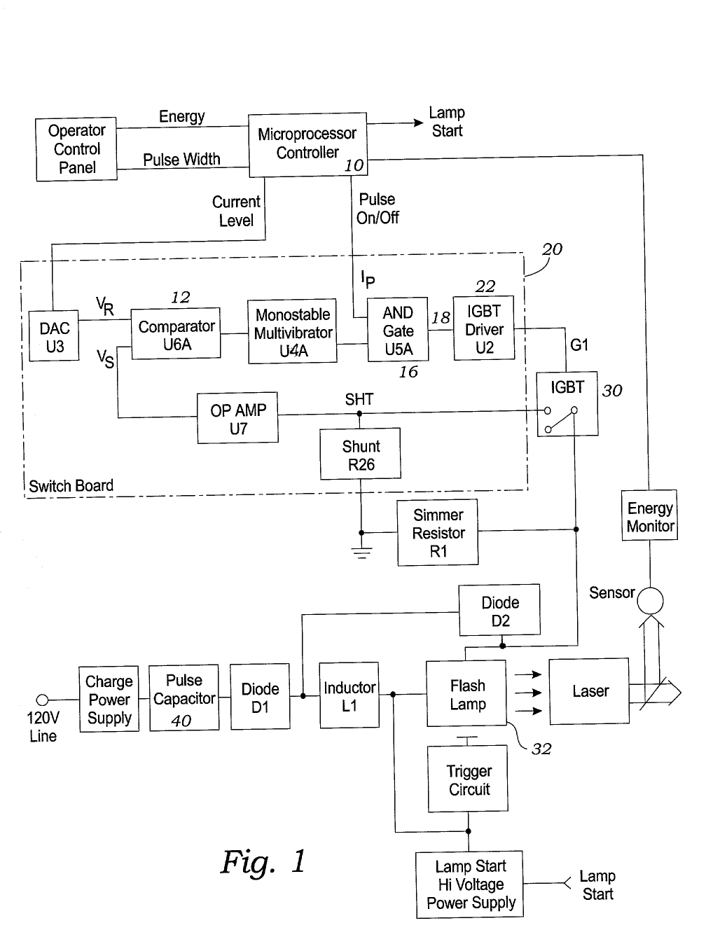

The laser pulse driving circuit of the present invention comprising: a software algorithm capable of producing a desired laser pulse energy level information and a laser pulse width information as is shown in FIG. 1 at the upper left. A microprocessor controller 10 of any industrial control type, well known in the art, is enabled for determining a target flashlamp current level corresponding to the laser pulse energy level information in, for instance, a one-to-one correspondence look-up table. A comparator 12 is enabled for receiving a reference voltage level V_{R} at a first input thereof. A power switch (IBGT) 30 is enabled for delivering an actual flashlamp current level to a flashlamp 32 from a pulse capacitor 40. A shunt resistor R26 provides a shunt voltage Vs proportional to the actual flashlamp current level at a second input of the comparator 12 through an OP AMP U7. The comparator 12, therefore, is adapted for turning-on a comparator output when the shunt voltage Vs is less than the reference voltage V_{R}. An AND (U5A) gate 16 is adapted for receiving the comparator output signal at a first AND gate input and for receiving a control signal Ip corresponding to the pulse width information from a microprossor controller 10, at a second AND gate input so as to produce an AND gate output 18 at a power switch driver U2 22 when both the first and the second AND gate inputs are present. The power switch driver 22 is adapted for closing the power switch 30 so that it is enabled for delivering the actual flashlamp current level from the pulse capacitor 40 when the AND gate output is present. Thus, the desired pulse energy level is applied to the flashlamp in a pulse having the desired laser pulse energy level and laser pulse width. Current smoothing inductor L1 is used to assure the averaging of transients in the incoming current through the IGBT.

In the above circuit, the method may be described in steps. The operator selects a desired laser pulse energy level, a laser pulse width and a repetition rate. This determines a target flashlamp current level corresponding to the desired laser pulse energy level. A reference voltage corresponding to the target flashlamp current level is then produced at a first input of a comparator. A power switch delivers the actual flashlamp current level to the flashlamp from the pulse capacitor. A shunt voltage proportional to the actual flashlamp current level is developed at a second input of the comparator. The comparator output is turned on when the shunt voltage is less than the reference voltage. The comparator output provides a first AND gate input. A control signal is provided by the microprocessor controller 10 at a second AND gate input for a time equal to the laser pulse width. The AND gate output controls the power switch driver 22, when both the first and the second AND gate inputs are present; and this closes the power switch to deliver the actual flashlamp current level from the pulse capacitor 40 when the AND gate output is present. Thus, the desired pulse energy level is applied to the flashlamp resulting in a laser pulse having the desired laser pulse energy level and laser pulse width.

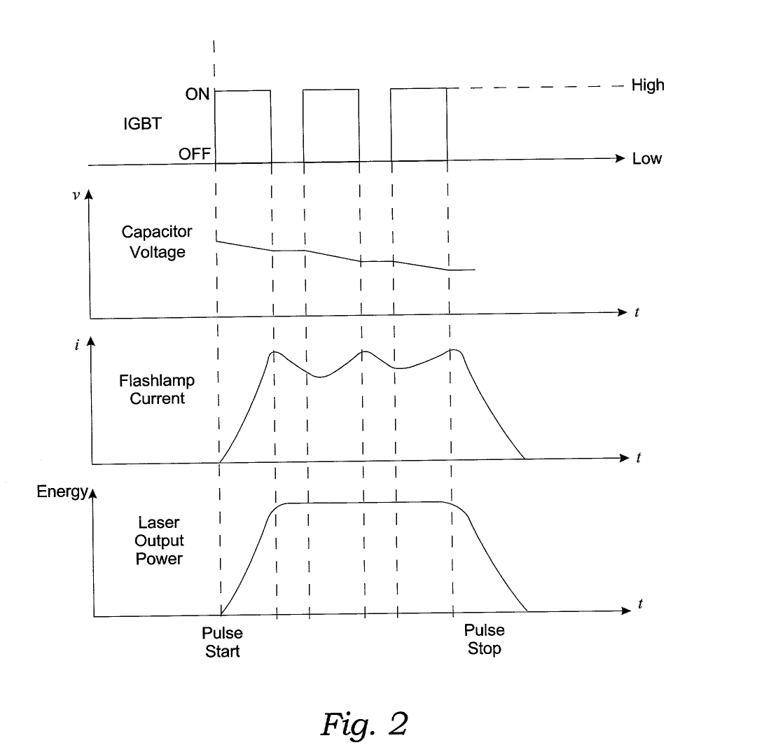

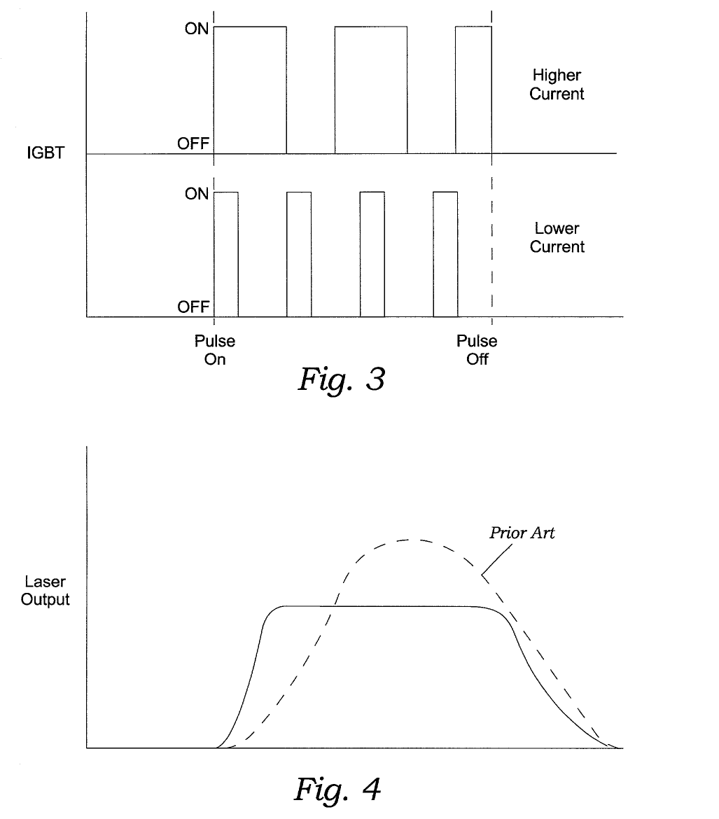

In further detail in the present invention, an operator selects a desired laser pulse energy level, laser pulse width and repetition rate on a control panel. The desired pulse is shown in solid line in FIG. 4. It should be noticed that the energy level of the prior art laser pulse is relatively more variable than the pulse of the instant invention. Since the magnitude of the pulse determines the regime, i.e., high energy for vaporizing tissue, for instance, in a surgical application, and medium energy for cauterization, and low energy for heating, it is desirable to control the laser output pulse over three parameters: total pulse energy delivered in the pulse, pulse duration and repetition rate. It should be noted that the repetition rate is preferably controlled between about 10 and 100 pulses per second, in that a rate outside of this range tends to be ineffective for the purpose set forth. Such a control panel may be of any common type, such as an industrial microprocessor operated controller 10 available in the commercial marketplace. The microprocessor controller 10 reads an operator input desired energy level and establishes a corresponding flashlamp current level to produce such. It sends a current level information as a digital signal to a switch board 20 at a serial connector. This signal is converted, on the switchboard 20, by a digital-to-analog converter (DAC, U3) to an analog reference voltage level V_{R}. V_{R} is therefore placed at a first input of comparator 12. When current is flowing through the flashlamp, a voltage develops across a shunt resistor R26, and this voltage is proportional to the current in the flashlamp. It is filtered through an operational amplifier, U7, and appears at the second input of the comparator 12. Whenever the shunt voltage Vs is less than Vr the output of the comparator turns on, i.e., when the current flowing through the flashlamp is less than the desired current. The output of the comparator 12 is sent to one input of an AND gate 16. The microprocessor controller 10 sends a signal Ip determined by the selected pulse width input by the operator, to the second input of the AND gate 16. As long as the laser output is requested by the operator, and for a period of time equal to the requested pulse width, the microprocessor controller sets the Ip signal to the On state. When both inputs to the AND Gate 16 are in the On state, the AND gate output is on, which activates the IGBT driver 30. This causes IGBT switch 30 to close, so that current is delivered from the pulse capacitor 40 to the flashlamp through current smoothing inductance L1. This current is delivered only when the Ip signal is in the On state and the voltage, as measured by R26 is below the set point, as set by V_{R}. Typically, during a single pulse, the current turns on and off several times to maintain the desired level through the flashlamp. Therefore, the pulse energy level and the pulse width are both set by the control signals on the switch board 20 and these can be varied over a wide range by operator control. This is to say, that the current delivered by the pulse capacitor 40 is switched between On and Off states periodically to maintain flashlamp current at a desired level. The capacitance is large enough to allow the current to be kept nearly constant for the duration of each laser pulse. FIG. 2 defines the on/off states of the IGBT and corresponding thereto, the voltage at pulse capacitor 40, the current in the flashlamp 32 and the energy waveform at the laser output. FIG. 3 illustrates how the IBGT would be operated for a higher current output and for a lower current output. It should be noticed that the laser output is monitored by a light sensor via an energy monitor circuit and microprocessor 10 to provide closed loop control after passing through a beam splitter. See FIG. 1.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A laser pulse driving method comprising the steps of: selecting a desired laser pulse energy level and a laser pulse width; determining a target flashlamp current level corresponding to the selected laser pulse energy level; generating a reference voltage corresponding to the target flashlamp current level; delivering an actual flashlamp current level to a flashlamp, the actual flashlamp current level approximating the target flashlamp current level; providing a voltage proportional to the actual flashlamp current level; providing a first signal when the proportional voltage is less than the reference voltage; providing a control as a second signal for a time duration equal to the selected laser pulse width; closing a power switch when the first and second signals are present, to deliver a flashlamp current having the actual flashlamp current level; whereby the selected target flashlamp current level is applied to the flashlamp resulting in a laser pulse controlled about the selected target pulse current level and with the selected laser pulse width.

2. The method of claim 1 comprising the further step of selecting the desired laser pulse energy level and the laser pulse width using a software algorithm.

3. The method of claim 2 comprising the further step of selecting the desired laser pulse energy level and the laser pulse width using a microprocessor controller.

4. The method of claim 2 comprising the further step of determining the target flashlamp current level through a look-up table stored in the software algorithm.

5. The method of claim 1 wherein the step of generating the reference voltage corresponding to the target flashlamp current level includes the step applying the target flashlamp current across a resistor.

6. The method of claim 1 wherein the power switch is an IGBT device

7. The method of claim 1 wherein the actual flashlamp current level is delivered to the flashlamp from a pulse capacitor.

8. The method of claim 7 wherein the first and second signals enable a comparator adapted for turning-on a comparator output to an AND gate.

9. The method of claim 8 wherein the AND gate further receives the control second signal for producing an AND gate output to the power switch driver.

10. The method of claim 8 wherein the power switch driver closes the power switch for delivering the actual flashlamp current level from the pulse capacitor when the AND gate output is present whereby the desired laser pulse energy level is applied to the flashlamp in a laser pulse having the desired laser pulse energy level and laser pulse width.

11. The method of claim 1 further comprising the step of selecting a laser pulse repetition rate between about 10 and 100 pulses per second.

12. A laser pulse driving apparatus comprising: a controller enabled for selecting a desired laser pulse energy level and a laser pulse width for determining a target flashlamp current level corresponding to the selected laser pulse energy level; a means for generating a reference voltage corresponding to the target flashlamp current level; a means for delivering an actual flashlamp current level to a flashlamp, the actual flashlamp current level approximating the target flashlamp current level; a means for providing a voltage proportional to the actual flashlamp current level; a means for providing a first signal when the proportional voltage is less than the reference voltage; a means for providing a control as a second signal for a time duration equal to the selected laser pulse width; a means for closing a power switch when the first and second signals are present, to deliver a flashlamp current having the actual flashlamp current level; whereby the laser pulse energy level is controlled about the selected target pulse current level with the selected laser pulse width.

13. The apparatus of claim 12 wherein the means for selecting the desired laser pulse energy level and the laser pulse width is a software algorithm.

14. The apparatus of claim 12 wherein the selecting means for selecting the desired laser pulse energy level and the laser pulse width is a microprocessor controller.

15. The apparatus of claim 12 wherein the means for determining the target flashlamp current level is a look-up table stored in the software algorithm.

16. The apparatus of claim 12 wherein the means for generating the reference voltage corresponding to the target flashlamp current level includes a resistor carrying the target flashlamp current.

17. The apparatus of claim 12 wherein the power switch is an IGBT device

18. The apparatus of claim 12 wherein the actual flashlamp current level is delivered to the flashlamp from a pulse capacitor.

19. The apparatus of claim 18 wherein the first and second signals enable a comparator adapted for turning-on a comparator output to an AND gate.

20. The apparatus of claim 19 wherein the AND gate is enabled for further receiving the control second signal for producing an AND gate output to the power switch driver.

21. The apparatus of claim 19 wherein the power switch driver is enabled for closing the power switch for delivering the actual flashlamp current level from the pulse capacitor when the AND gate output is present whereby the desired laser pulse energy level is applied to the flashlamp in a laser pulse having the desired laser pulse energy level and laser pulse width.

22. The apparatus of claim 11 further comprising means for controlling a laser pulse repetition rate between about 10 and 100 pulses per second.
